(19) United States
(12) Patent Application Publication
(10) Pub. No.: US 2019/0354207 A1
(43) Pub. Date: Nov. 21, 2019

(54) OPERATION DEVICE

(71) Applicant: DENSO CORPORATION, Kariya-city (JP)

(72) Inventor: Kazuo KITO, Kariya-city (JP)

(21) Appl. No.: 16/525,171

(22) Filed: Jul. 29, 2019

Related U.S. Application Data
(63) Continuation of application No. PCT/JP2018/015530, filed on Apr. 13, 2018.

(30) Foreign Application Priority Data
Jun. 15, 2017 (JP) 2017-117678

(51) Int. Cl. G06F 3/041; G06F 3/0488; G06F 3/02

(52) U.S. Cl. CPC G06F 3/041; G06F 3/02; G06F 3/0488

(57) ABSTRACT

An operation device includes a surface panel, a static capacitance detection unit, mat-shaped small pieces, a vibration plate and a vibration generator. The surface panel is provided with plural operation buttons virtually. The static capacitance detection unit detects a touch operation on each of the operation buttons. The mat-shaped small pieces are provided on a back surface of the surface panel in correspondence to the operation buttons, respectively. The vibration plate is provided across the plural small pieces and transmits vibration to the small pieces. The vibration generator vibrates the vibration plate when the operation button is touch-operated.

### CROSS REFERENCE TO RELATED APPLICATIONS

The present application is a continuation application of International Patent Application No. PCT/JP2018/015530 filed on Apr. 13, 2018, which designated the United States and claims the benefit of priority of Japanese Patent Application No. 2017-117678 filed on Jun. 15, 2017. The entire disclosures of both applications are incorporated herein by reference.

### FIELD

The present disclosure relates to an operation device.

### BACKGROUND

In one example of a touch panel type operation device, which may be mounted in a vehicle such as an automotive vehicle, plural operation sections are provided on a surface panel. A mark or the like is displayed on each operation section. This operation device has a capacitive type touch sensor, which detects a finger touch of a user on either operation section and outputs an operation signal. In such a touch panel type operation device, in recent years, a mechanism having a tactile feedback function is proposed to provide the user with an operation feeling like pressing a push button during touch operation.

For this tactile feedback function, an actuator such as a piezo-electric element is provided on a back surface of the panel thereby to apply vibration to the panel. In this type of touch panel type operation device, the plural operation sections are generally provided side by side on one panel. The piezo-electric actuator is provided for each operation section to apply vibration individually. Alternatively, one piezo-electric actuator is provided to apply vibration to a whole panel.

### SUMMARY

The present disclosure provides a touch panel type operation device having a tactile feedback function. In the operation device, a surface panel is provided with plural operation buttons virtually, a static capacitance detection unit detects a touch operation on each of the operation buttons, plural mat-shaped small pieces are provided on a back surface of the surface panel in correspondence to the operation buttons, respectively, a vibration plate is provided across the plural small pieces to transmit vibrations to the small pieces, and a vibration generator vibrates the vibration plate when the operation button is touch-operated.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a perspective view of an instrument panel including an operation device according to a first embodiment;

FIG. 2 is an enlarged front view of the operation device;

FIG. 3 is a block diagram of an electrical configuration of the operation device;

FIG. 4 is a top sectional view of the operation device;

FIG. 5 is an exploded view of a surface panel unit and panel members;

FIG. 6 is a side sectional view of the operation device;

FIG. 7 is a front view of a vibration application structure of an operation device according to a second embodiment; and

FIG. 8 is a side sectional view of the vibration application structure.

### EMBODIMENT

### First Embodiment

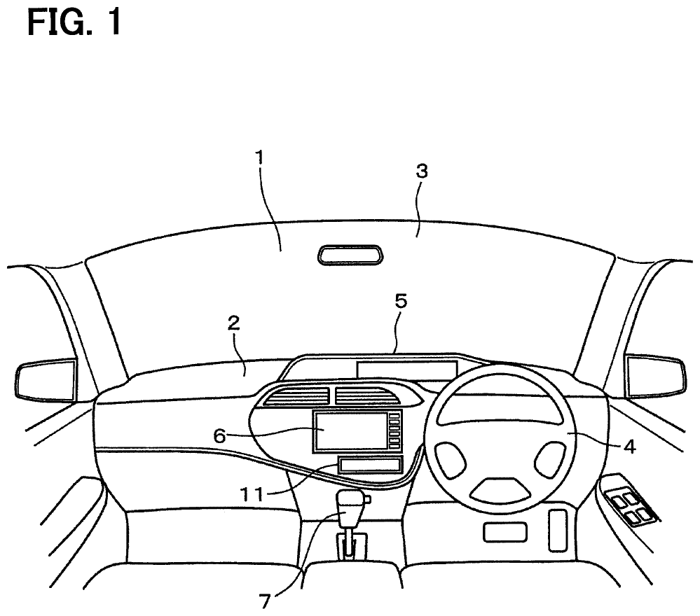

Hereinafter, a first embodiment of an operation device applied to an operation panel for operating an air conditioner of an automotive vehicle will be described with reference to FIG. 1 to FIG. 6. In case it is necessary to refer to directions such as front, rear, left and right in the following description, the directions are defined relative to a driver assumed to be on a driver's seat in a vehicle compartment and facing in a moving direction of the vehicle. That is, FIG. 1 shows a state in which an instrument panel 2 provided at a front part of the vehicle is viewed from inside a passenger compartment 1 of the vehicle. In this figure, the driver's seat is on a right side, and a front passenger's seat is on a left side.

As shown in FIG. 1, the instrument panel 2 is provided extending laterally in the left and right direction at a front side of the passenger compartment 1, and a windshield 3 is provided over the instrument panel 2. A steering wheel 4 is provided at the front of the right side between the instrument panel 2 and the driver's seat. A meter 5 and a center display 6 etc. are provided in a center part of the instrument panel 2. Further, an operation device, that is, air conditioner panel 11 for controlling air conditioner operation is provided in the center part of the instrument panel 2. A shift lever 7 is provided at a center console between the driver's seat and the front passenger's seat.

Although not shown in detail in FIG. 1, an air conditioner system having a known configuration is mounted in the vehicle. The air conditioner system is controlled by an air conditioner control device 8 including a computer as described later with reference to FIG. 3. The operation device (air conditioner panel) 11 according to the present embodiment is for a user such as a driver to issue an input instruction to control the air conditioner operation. An air conditioner operation signal generated in response to the user's operation on the operation device 11 is input to the air conditioner control device 8.

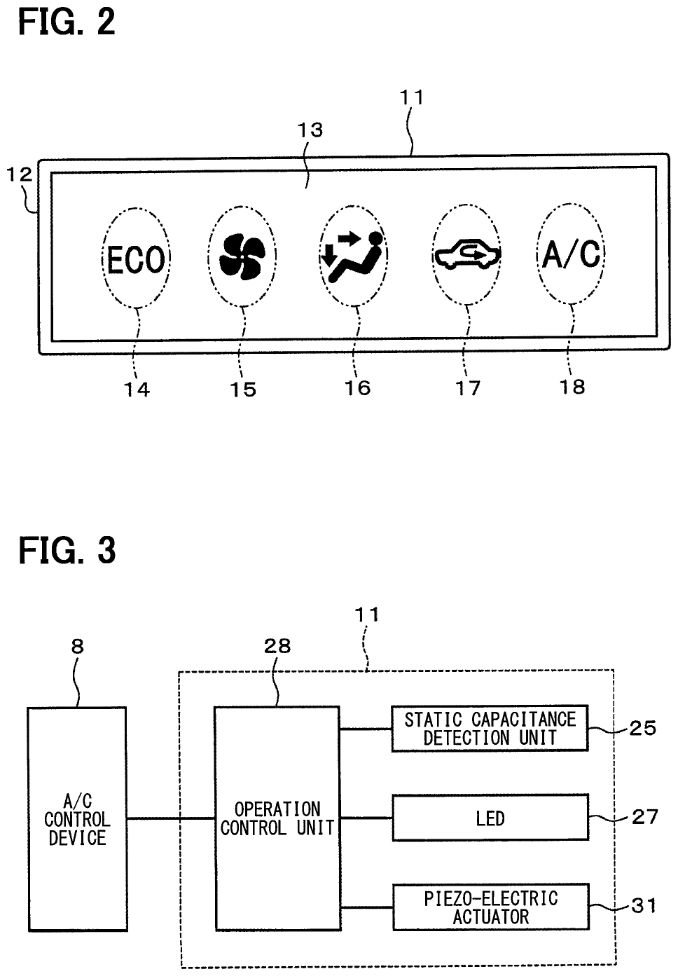

The configuration of the operation device 11 will be described in detail with reference to FIG. 2 to FIG. 6. The operation device 11 is configured as a unit by incorporating plural mechanisms in a case-like mounting base 12, which is in a horizontally elongated rectangular shape and is thin in the front-back direction. The front surface of the mounting base 12 is open. A horizontally elongated rectangular surface panel 13 is fitted in this front opening of the mounting base 12. As shown in FIG. 2, on the surface panel 13, plural, for example, five operation buttons 14 to 18 which a user performs touch operation with a finger are virtually provided in line in a horizontal row.

Specifically, from left to right, the operation button 14 is for “economy driving,” the operation button 15 is for “air volume switching,” the operation button 16 is for “air blow mode switching,” the operation button 17 is for “internal/external air switching,” and the operation button 18 is for “air conditioner on/off switching.” In this example, a slightly vertically elongated elliptical area indicated by a broken line in FIG. 2 defines each touch operation area. As shown in FIG. 2 only, the surface panel 13 has marks or characters at the center of each elliptical area of the operation buttons 14 to 18, respectively, thereby to indicate functions (types) of the operation buttons 14 to 18.

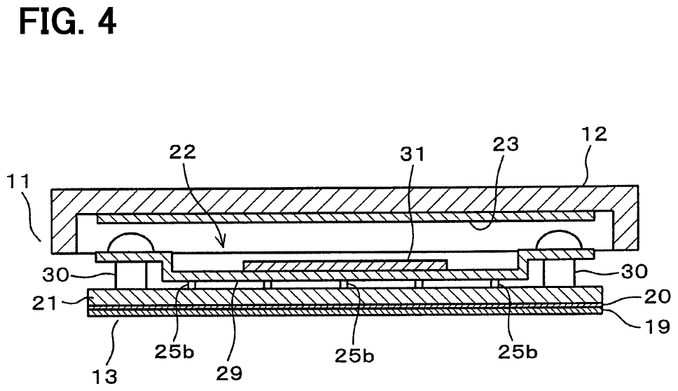

As shown in FIG. 4 to FIG. 6, the surface panel 13 is formed of a decorative film 19 provided on a front surface side and a static film 20 superimposed on a back surface side of the decorative film 19 by adhesion. The operation device 11 includes one panel member 21, a vibration application mechanism 22 for realizing a tactile feedback function and a circuit board 23 sequentially from the front surface side to the back surface side of the surface panel 13, that is, in the mounting base 12.

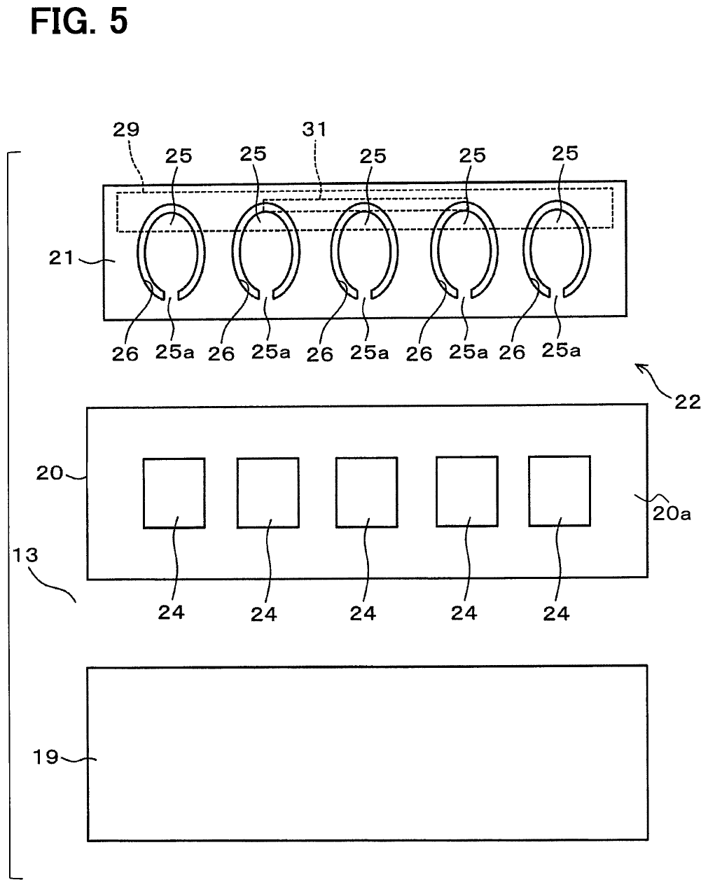

Although not shown in detail, the decorative film 19 has a light shielding part formed substantially over an entire surface of a transparent film having a horizontally elongated rectangular shape, and the marks and characters indicating the operation buttons 14 to 18 are formed in a transparently shaped state. Further, as partially shown in FIG. 5, the static film 20 has, on a surface of a transparent base film 20a, plural static capacitance detection units 24, which correspond to the operation buttons 14 to 18 in position and wiring (not shown). The static film 20 has a configuration in which the surface of the base film 20a is covered with a transparent cover film.

As is well known, each static capacitance detection unit 24 detects that the operation button 14 to 18 on the surface of the surface panel 13 is touch-operated (proximity operation) with a finger of a user in response to a change in the static capacitance. The capacitance detection units 24 are formed by printing and applying a semi-transparent conductive polymer in, for example, a square shape, at positions of the base film 20a in correspondence to the operation buttons 14 to 18, respectively. Although not shown, an end of the static film 20 is provided with a connecting part for making an electrical connection to the circuit board 23.

The panel member 21 is made of a rigid plastic plate made of transparent acrylic resin or the like, formed in a horizontally elongated rectangular shape, and adhered to a back surface of the surface panel 13 (static film 20). In the present embodiment, as shown in FIG. 5, five mat-like small pieces 25 in this case for realizing the function of a tactile feedback are integrally formed in the panel member 21 at positions corresponding to the operation buttons 14 to 18. The small pieces 25 are provided in a slightly elongated elliptical shape corresponding to the operation buttons 14 to 18. Each small piece 25 is formed by providing a cut-out groove 26 along an outer peripheral edge of the elliptical area while partly maintaining a connecting part 25a for securing a connection with the panel member 21.

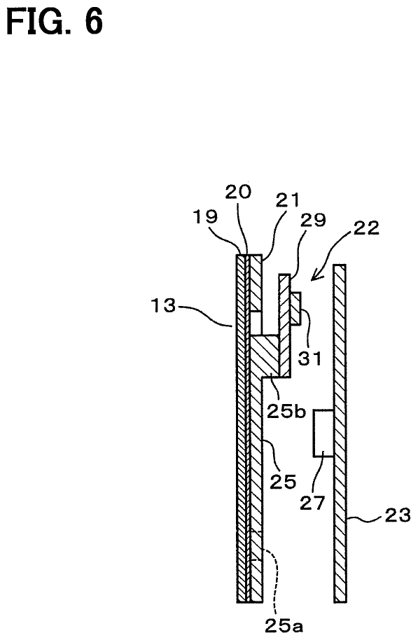

In this case, the connecting part 25a is located at a lowermost end of the small piece 25. Thus, each small piece 25 is provided like a tongue to the panel member 21 so as to be able to vibrate with the connecting part 25a as a fulcrum. Further, as shown in FIG. 6, on the back side of each small piece 25, a projection 25b is formed integrally so as to be convex toward the back surface side, that is, toward the circuit board 23. The projection 25b is provided at an upper end, which is separated from and opposite to the connecting part 25a, and connected to the vibration application mechanism 22, which is a vibration plate described later. The outer peripheral edge of the panel member 21 is fixed to the mounting base 12. The details of the vibration application mechanism will be described later.

The circuit board 23 is located along an inside wall of the mounting base 12 as shown in FIG. 4. On a front surface of the circuit board 23, as shown in FIG. 6, LEDs 27 (only one shown) serving as light sources for displaying the operation buttons 14 to 18, respectively, are mounted. Although not shown in detail, the circuit board 23 is provided with an operation control unit 28 (refer to FIG. 3), which includes a current supply circuit for driving the LEDs 27, a signal processing circuit for the static capacitance detection unit 25 and a current supply circuit for driving the vibration application mechanism 22.

The configuration of the vibration application mechanism 22 in the present embodiment will be described below. That is, as shown in FIG. 4 to FIG. 6, the vibration application mechanism 22 includes a vibration plate 29 attached to the back surface side of the panel member 21, particularly to the small pieces 25, a bracket 30 for supporting the vibration plate 29 and a piezo-electric actuator 31 as a vibration generation device. The vibration plate 29 is made of a metal plate spring material, and is elongated in the horizontal direction, that is, lateral direction in the figure, so as to straddle and link the five small pieces 25. A tip of the projection 25b of each of the small pieces 25 is attached to the vibration plate 29 by adhesion to transmit vibration to the small pieces 25.

Both lateral end portions of the vibration plate 29 are bent into a stepped shape and fixed to the mounting base 12 (panel member 21) by screws via brackets 30, respectively. The piezo-electric actuator 31 is elongated in the lateral direction, that is, left-right direction in FIG. 5, and attached to the back surface side of the vibration plate 29 as shown in FIG. 6. The piezo-electric actuator 31 has a known configuration using a piezo-electric element and is configured to generate vibration in response to current supply and vibrate the vibrating plate 29 back and forth, that is, in the left-right direction in FIG. 6. At this time, the operation control unit 28 controls the current supply to the piezo-electric actuator 31.

As shown in FIG. 3, the operation control unit 28 includes a computer (CPU), and monitors the touch operation on each of the operation buttons 14 to 18 based on the detection signal of the static capacitance detection unit 24. Upon detection of the touch operation on each of the operation buttons 14 to 18, the operation control unit 28 drives the piezo-electric actuator 31 for a short time to vibrate the respective operation buttons 14 to 18 of the surface panel 13. In this way, the function of tactile feedback that imparts an operational feeling to the user's finger is realized. Further, the operation control unit 28 controls lighting and extinguishing of each LED 27 in accordance with the touch operation on each of the operation buttons 14 to 18. At the same time, the operation control unit 28 outputs an air conditioner operation signal corresponding to the touch operation on each of the operation buttons 14 to 18 to the air conditioner control device 8.

Next, the operation and effect of the operation device 11 configured as described above will be described. The operation device 11 has plural (five) operation buttons 14 to 18 arranged in a row on its surface so that a user performs an input instruction such as setting an operation state of the air conditioner system by touch-operating any of the operation buttons 14 to 18. In this case, the touch operation on the operation buttons 14 to 18 is detected as a change in capacitance in the capacitance detection unit 24. The operation control unit 28 responsively outputs the air conditioner operation signal based on the detected capacitance change.

When a touch operation is performed on any of the operation buttons 14 to 18, the piezo-electric actuator 31 is driven with current supply by the operation control unit 28. Then, the vibration generated by the piezo-electric actuator 31 is transmitted to the vibration plate 29 and is transmitted to all of the small pieces 25 connected to the vibration plate 29, thereby vibrating the small pieces 25. Thus, vibration is applied to the small pieces 25 by the vibration application mechanism 22, and the vibration gives an operation feeling to the finger of the user who has operated the operation buttons 14 to 18.

According to the configuration of the vibration application mechanism 22 of the present embodiment, the plural mat-like small pieces 25 are vibrated without vibrating an entirety of the panel member 21 (surface panel 13). Therefore, it becomes possible to transmit the vibration generated by the piezo-electric actuator 31 to substantially only the small pieces 25 with a sufficiently large force. Further, unlike a case where a vibration generation device is provided for each of the operation buttons 14 to 18, one piezo-electric actuator 31 is provided in common in a form shared by the plural operation buttons 14 to 18. Therefore, the number of vibration generation devices (piezo-electric actuators 31) need not be increased to the number of the operation buttons 14 to 18, and the vibration application mechanism 22 can be small-sized and simplified.

In the present embodiment, the touch panel type operation device 11 having the function of haptic feedback includes the small pieces 25, the vibration plate 29 and the piezo-electric actuator 31. The small pieces 25 are provided in correspondence to the operation buttons 14 to 18, respectively. The vibration plate 29 is provided to bridge the small pieces 25 to transmit vibration to the small pieces 25. The piezo-electric actuator 31 vibrates the vibration plate 29. As a result, according to the present embodiment, it is possible to impart a sufficient operational feeling to each of the operation buttons 14 to 18 while having a relatively simple configuration.

Further, particularly in the present embodiment, the plural small pieces 25 are provided relative to one panel member 13 provided on the back surface of the surface panel 13. Each small piece 25 is provided by forming the cut-out groove 26 along the outer peripheral edge of each operation button 14 to 18 except for the connecting part 25a. As a result, since the plural small pieces 25 are provided in one panel member 21, the configuration is simplified as compared to the case where the individual small pieces are separately formed. Since each small piece 25 is connected to the panel member 21 at the connecting part 25a integrally, the individual small pieces 25 do not fall apart and are not separated from the panel member 21, so that handling is easy and assembly work and the like become simplified.

Each connecting part 25a is formed at the lower end side of each small piece 25. The projection 25b to which the vibration plate 29 is connected is provided at the upper end side of each small piece 25. The vibration plate 29 transmits the vibration to the plural small pieces 25 at the position separated from the connecting part 25a. Thus, even if the connecting part 25a partially connects the small piece 25 to the panel member 21, the vibration can be effectively transmitted to the small piece 25. Furthermore, in the present embodiment, the piezo-electric actuator 31 using the piezo-electric element is adopted as the vibration generation device, it is possible to provide the vibration application device in a compact size and a comparatively low cost.

### Second Embodiment

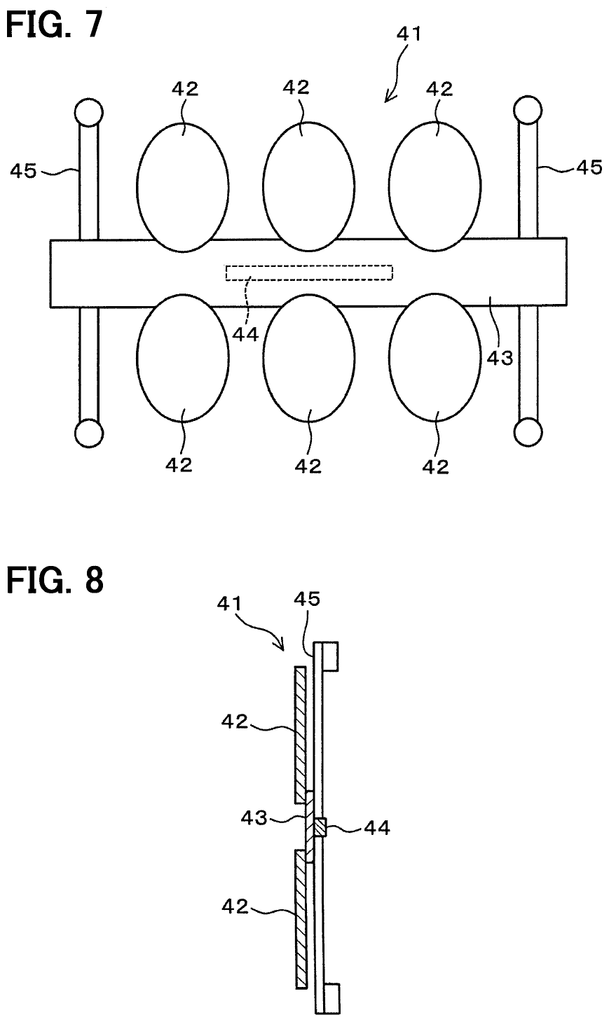

FIG. 7 and FIG. 8 show a second embodiment. An operation device according to the second embodiment is different from the operation device 11 according to the first embodiment in the following configuration. That is, although not shown in detail, the operation device according to the second embodiment also has a surface panel on a front surface of a mounting base, and a vibration application mechanism 41 and a circuit board on the back surface side of the surface panel, that is, inside the mounting base. On the front surface of the surface panel (not shown), a total of six operation buttons each having a slightly elongated elliptical shape are virtually provided. The six operation buttons are arranged in two rows in up-down direction and three columns in left-right direction.

On the back surface of the surface panel, six elliptical mat-like small pieces 42 are provided in correspondence to the six operation buttons. The vibration application mechanism 41 includes a vibration plate 43 and a piezo-electric actuator 44. The vibration plate 43 is made of a metallic leaf spring elongated in the lateral direction, that is, in the horizontal (left-right) direction, and provided to bridge the six small pieces 42. The piezo-electric actuator 44 is provided as the vibration generation device for vibrating the vibration plate 43. As shown in FIG. 7, the vibration plate 43 has a horizontally elongated rectangular plate shape. An upper side of the vibration plate 43 is connected to the lower end of each of the three small pieces 42 located in the upper side for transmission of vibration to the small pieces 42 of the upper side. A lower side of the vibration plate 43 is connected to the upper end of each of the three small pieces 42 for transmission of vibration to the small pieces 42 of the lower side. The piezo-electric actuator 44 has an elongated shape in the left-right direction and attached to the back surface side of the vibration plate 43. Thus the piezo-electric actuator 44 generates vibration in response to current supply and vibrates the vibration plate 43 back and forth.

In the present embodiment, the vibration plate 43 is supported by support members 45 attached to the mounting base. The support members 45 are in the form of bars extending in the vertical direction and positioned on the left and right in the mounting base. Upper and lower ends of the support members 45 are fixedly attached to the mounting base. The vibration plate 43 is connected to a vertical middle portion of the supporting members 45, that is, a portion floating from the mounting base so that the vibration plate 43 and the supporting members 45 form an H shape. Thus, both ends of the vibration plate 43 are resiliently supported relative to the mounting base.

In this second embodiment, when one of the six operation buttons is touch-operated, the vibration generated by the piezo-electric actuator 44 is transmitted to the vibration plate 43 and then to the six small pieces 42, which responsively vibrate. Thus, with vibration applied to the small pieces 42, the vibration gives an operation feeling to the finger of the user who has touched any one of the operation buttons 14 to 18. Thus, it becomes possible to transmit the vibration generated by the piezo-electric actuator 44 to each of the small pieces 42 with a sufficiently large force. Further, only one piezo-electric actuator 44 is provided in a form shared by the six operation buttons.

According to the second embodiment, the touch panel type operation device having the function of haptic feedback provides an advantageous effect that each operation button can give sufficient operation feeling to the finger of the user in a simple configuration. Since the piezo-electric actuator 44 using the piezo-electric element is adopted as the vibration generation device, it is possible to provide the operation device in compact size and low cost.

Further, in the present embodiment, both lateral ends of the vibration plate 43 are resiliently supported relative to the mounting base. Here, in case both ends of the vibration plate 43 are firmly fixed to the mounting base, the vibration is dampened and hence the vibration at both ends of the vibration plate 43 is necessarily weakened in comparison to the central portion. However, in the present embodiment, both lateral ends of the vibration plate 43 are elastically supported. As a result, it is possible to suppress the attenuation of the vibration and maintain relatively strong vibration even at the lateral end side of the vibration plate 43. It is thus possible to provide a uniform operation feeling for the entire operation device.

### Other Embodiment

In the second embodiment, both lateral ends of the vibration plate 43 are attached to the middle portions of the support members 45. However, it is possible to interpose a spring between them. Thereby, dampening of the vibration can be suppressed further. In each of the above embodiments, one piezo-electric actuator is provided for the plural small pieces of the operation buttons. However, in case the number of operation buttons is increased, two or more sets of vibration generation devices may be provided so that each of the plural operation buttons is provided to vibrate plural small pieces which correspond to plural operation buttons. Further, a motor actuator and the like may be used as the vibration generation device in place of the piezo-electric actuator using the piezo-electric elements. The surface panel may be configured differently with various modifications.

In the above embodiments, although the operation device is implemented exemplarily in an operation panel of an in-vehicle device such as the air conditioner, it may be implemented in other operation devices for different applications and types. Of course, the type, arrangement and number of operation buttons may be changed.

Although the present disclosure has been made in accordance with the embodiments, it is understood that the present disclosure is not limited to such embodiments and structures. The present disclosure covers various modification examples and equivalent arrangements. In addition, while various combinations and configurations, which are preferred, are described, other combinations and configurations including further only a single element, more or less, are also within the spirit and scope of the present disclosure.

What is claimed is:

1. An operation device comprising:
a surface panel on which plural operation buttons are provided virtually;
a static capacitance detection unit for detecting a touch operation on each of the operation buttons;
plural small pieces provided on a back surface of the surface panel in correspondence to the operation buttons and mat-shaped, respectively;
a vibration plate provided across the plural small pieces and transmitting vibrations to the small pieces; and
a vibration generator for vibrating the vibration plate when the operation button is touch-operated.

2. The operation device according to claim 1, further comprising:
a back panel provided on a back surface of the surface panel,
wherein the back panel has cut-out grooves along outer peripheries of areas corresponding to the plural the operation buttons partly leaving connecting parts.

3. The operation device according to claim 2, wherein:
the plural small pieces are connected to the vibration plate to receive vibration from the vibration plate at positions spaced apart from the connecting parts.

4. The operation device according to claim 1, wherein:
both lateral ends of the vibration plate are supported resiliently against a mounting base.

5. The operation device according to claim 1, wherein:
the vibration generator includes a piezo-electric element.

6. The operation device according to claim 1, wherein:
the plural small pieces are divided into upper and lower rows;
the plural small pieces in the upper row are connected to the vibration plate at lower positions thereof; and
the plural small pieces in the lower row are connected to the vibration plate at upper positions thereof.
